(19) United States
(12) Patent Application Publication
(10) Pub. No.: US 2006/0230213 A1
(43) Pub. Date: Oct. 12, 2006

(54) Digital signal system with accelerators and method for operating the same

(75) Inventors: Ivo Tousek, Stockholm (SE); Tommy Eriksson, Hagersten (SE); Niklas Persson, Solna (SE)

Correspondence Address: David I. Roche;BAKER & McKENZIE LLP, 130 E. Randolph Drive, Chicago, IL, 60601, US

(73) Assignee: VIA Technologies, Inc.

(21) Appl. No.: 11/093,195

(22) Filed: Mar. 29, 2005

(51) Int. Cl. G06F 13/14

(52) U.S. Cl. 710/305

(57) ABSTRACT

A DSP system includes a DSP processor, at least one accelerator and an accelerator interface connected between the DSP processor and the at least one accelerator. The accelerator interface includes an accelerator instruction bus to convey instructions from the DSP processor to the accelerators. The DSP processor assigns an accelerator field in the instruction when the instruction is used to access the accelerators and further assigns an accelerator ID field in the instruction when the DSP processor selects a specific accelerator. The instruction also contains information to indicate a register address in the DSP processor and the command sent to the elected accelerator.

### BACKGROUND OF THE INVENTION

1. Field of the Present Invention

The present invention relates to a digital signal system with accelerators and method for operating the same, and further to a digital signal system in which a DSP processor sends instruction to accelerators through a dedicated accelerator identification bus and a designated accelerator can be identified by accelerator ID information contained in the instructions.

2. Prior art of the Present Invention

A processor such as a general-purpose microprocessor, a microcomputer or a digital signal-processing (DSP) unit, can process data according to an operation program. The modern electronic device demanding intensive computation generally distributes processing tasks to different processors. For example, the mobile communication devices contain a DSP unit for dealing with digital signal processing (such as speech encoding/decoding, and modulation/demodulation), and a general-purpose microprocessor unit for dealing with communication protocol processing.

The DSP unit may be incorporated with an accelerator for performing a specific task such as waveform equalization, thus further optimizing the performance thereof. As shown in FIG. 1, U.S. Pat. No. 5,987,556 discloses a data processing device having an accelerator for digital signal processing, and the data processing device 100 comprises a processor 120 such as a DSP processor, an accelerator 140 with an output register 142, a memory 112 and an interrupt controller 121. The accelerator 140 is connected to the processor 120 through data bus, address bus and R/W control line. The accelerator 140 is commanded, through the R/W control line, by the processor 120 to read data from or write data to the microprocessor core 120. The disclosed data processing device uses the interrupt controller 121 to halt the data accessing between the accelerator 140 and the processor 120 when an interrupt request with high priority is sent to and acknowledged by the processor 120. However, the microprocessor core 120 lacks the ability to identify different accelerators; therefore, the functionality of the data processing device is limited.

US pre-grant publication 2003/0005261 discloses a method and apparatus for attaching an accelerator hardware containing an internal state to a processing core. The apparatus discloses an accelerator with an internal state to increase the ratio of computation operations to the memory bandwidth available from a digital signal processor. The number of the accelerator can be augmented. However, those accelerators are separately attached to corresponding execution pipelines of the execution unit. The disclosed apparatus still lacks the ability to identify different accelerators.

### SUMMARY OF THE INVENTION

The present invention provides a digital signal system with accelerators and method for operating the same. The present invention further provides an instruction format, which contains information for identifying at least one accelerator for a DSP processor. The instruction format further contains information for indicating a usage condition of the registers in the DSP processor and accelerators.

In one aspect of the present invention, an accelerator interface is connected between a DSP processor and a plurality of accelerators. The accelerator interface comprises an accelerator identification (ACC_ID) bus for conveying instructions sent from the DSP processor to all the accelerators. The accelerator interface further comprises a write data bus shared by the accelerators, and a plurality of read data buses for the accelerators or cluster of accelerators, respectively.

In another aspect of the present invention, a DSP system comprises a DSP processor, a plurality of accelerators and an accelerator interface connecting the DSP processor and the plurality of accelerators. The DSP processor sends instructions to the accelerators through a dedicated bus of the accelerator interface. The instructions contain information for manifesting an accelerator-related command and for designating a specific accelerator in case that the DSP processor intends to access the specific accelerator.

In still another aspect of the present invention, the DSP processor and accelerators are configured to support a pipeline mode or slave mode operation when the DSP processor commands the accelerators through an accelerator instruction according to the present invention. The DSP processor confirms the execution of instructions by polling the accelerators or receiving an interrupt request from the accelerators.

### BRIEF DESCRIPTION OF THE DRAWINGS

FIG. 1 depicts a block diagram of a prior art data processing device having an accelerator.

FIG. 2 shows the schematic diagram of a DSP system according to a preferred embodiment of the present invention.

FIG. 3 shows the instruction format according to another preferred embodiment of the present invention.

FIG. 4 shows the schematic diagram of a DSP system according to another preferred embodiment of the present invention.

FIG. 5 shows the schematic diagram of a DSP system according to still another preferred embodiment of the present invention.

FIGS. 6A to 6H are flowcharts demonstrating the execution of accelerator instructions according to embodiments of the present invention.

FIG. 7 shows a flowchart for operating a DSP system according to another preferred embodiment of the present invention.

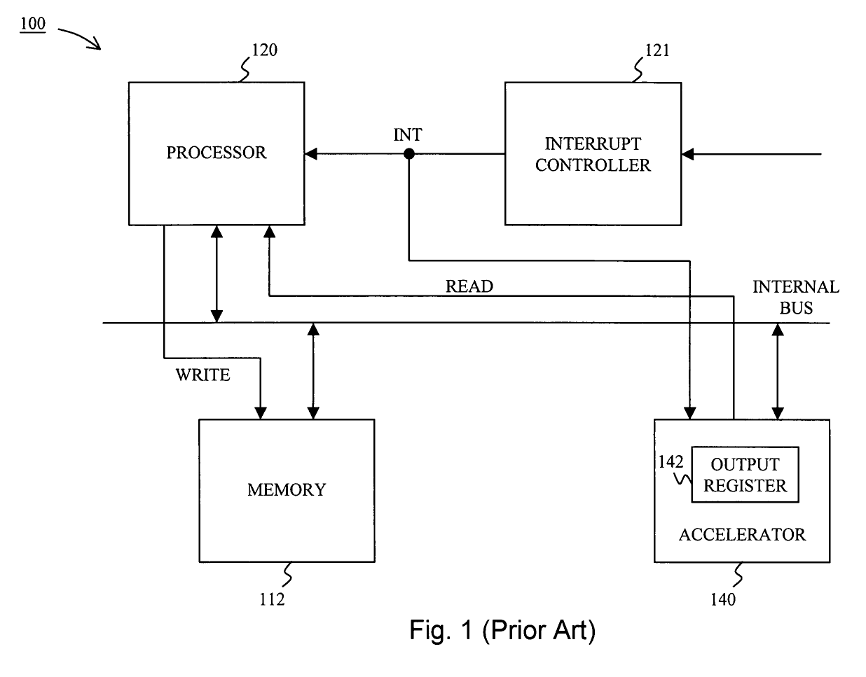

### DETAILED DESCRIPTION OF THE INVENTION

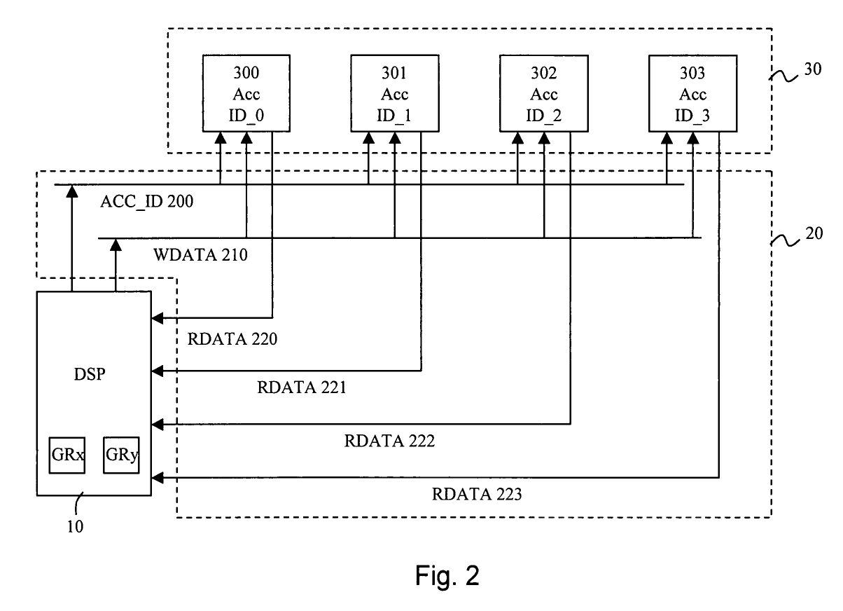

FIG. 2 shows the schematic diagram of a DSP system according to a preferred embodiment of the present invention. The DSP system comprises a DSP processor 10, a plurality of accelerators 300, 301, 302 and 303 and an accelerator interface 20 connected between the DSP processor 10 and the plurality of accelerators 300-303. The DSP processor 10 is, for example, a single-instruction issue DSP core with a 24-bit fixed-width instruction set. However, this is for illustration purpose and the DSP processor 10 could have instruction sets of other bit width. The accelerator interface 20 consists of a 24-bit ACC_ID bus 200, a 32-bit write data (WDATA) bus 210 and four 32-bit read data (RDATA) buses 220, 221, 222 and 223. The ACC_ID bus 200 is used to forward 24-bit accelerator instructions sent from the DSP processor 10 and the WDATA bus 210 is used to forward data to all accelerators that are connected to the accelerator interface 20. In this preferred embodiment, there are four RDATA buses 220, 221, 222 and 223 with number corresponding to that of the connected accelerators. Therefore, simple integration can be provided with multiple accelerators. However, the RDATA buses can be set to other number and logic unit such as multiplexers can be used to switch communication between the RDATA buses and the accelerators.

As also shown in this figure, the accelerators 300, 301, 302 and 303 are assigned with accelerator identification ID_0, ID_1, ID_2, and ID_3, respectively. The accelerators 300-303 are commonly connected to the DSP processor 10 through the shared ACC_ID bus 200. Therefore, all instructions issued by the DSP processor 10 are visible on the ACC_ID bus 200 for all accelerators 300-303. The accelerators 300-303 are commonly connected to the DSP processor 10 through the shared WDATA bus 210. Moreover, the accelerators 300-303 are individually connected to the DSP processor 10 through the dedicated RDATA buses 220, 221, 222 and 223, respectively. The DSP processor 10 can select a specific accelerator 30x with ID_x by issuing an instruction indicating accelerator-related command and containing an accelerator ID_x for designating the accelerator 30x. The instruction format will be detailed below.

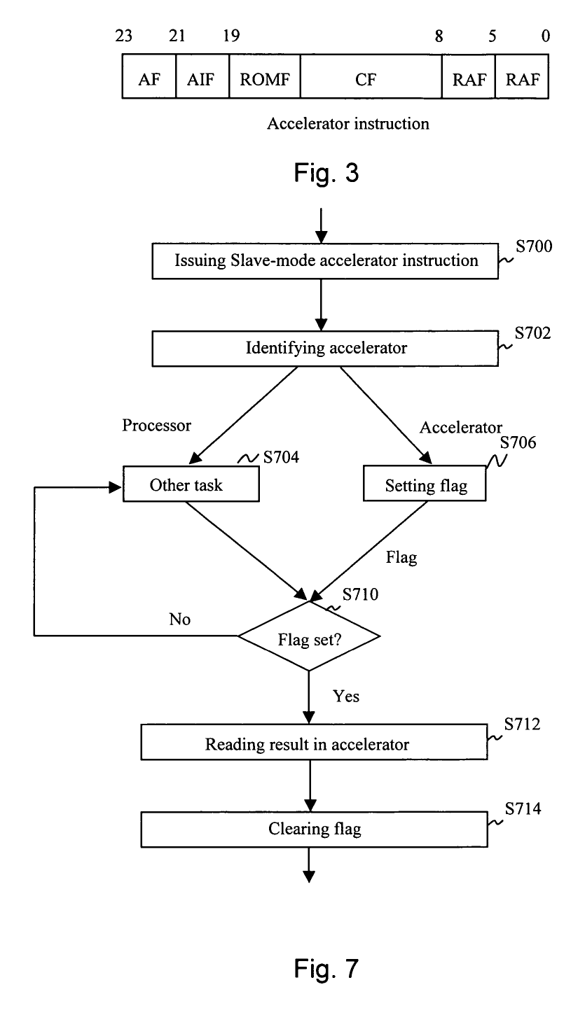

FIG. 3 shows the schematic diagram of the instruction format used for the accelerators connected to the accelerator interface according to a preferred embodiment of the present invention. The instruction set of the accelerator has a 24-bit width and comprises an accelerator field AF to distinguish accelerator instructions from other DSP processor instructions, an accelerator ID field AIF to identify a specific accelerator connected to the DSP processor 10 through the accelerator interface 20, a register operation mode field ROMF to indicate a usage condition for internal registers of the selected accelerator and a usage condition for internal registers of the DSP processor 10, a custom field CF to indicate a command code for the selected accelerator and to convey other information, and optionally a register address field RAF to indicate the address of at least one internal register in the DSP processor. It should be noted that the above instruction format is for demonstration and certain fields, except accelerator field, can be optionally used and other fields can also be included and implemented. The bit width and field position can also be modified by those skilled in the related art.

As shown in FIG. 3, the accelerator field AF comprises bits 22 and 23 to distinguish the accelerator instructions from other DSP processor instructions. The bit width of the accelerator field AF may be varied to adjust the coding space of an instruction set for the accelerator. The accelerator ID field AIF comprises bits 20 and 21 to identify a specific accelerator. The bit width of the accelerator field AF and accelerator ID field AIF could be varied according to the designer choice and practical requirements. For example, the bit width of the accelerator ID field AIF can be augmented to designate more accelerators.

The accelerator instructions are designed to use 4 or 8 bits to select one or more out of 16 internal 16-bit registers in the DSP processor 10. The registers can be the source data registers on the WDATA bus 210 when the DSP processor 10 intends to write data of the registers to a selected accelerator. Alternatively, the registers can be the destination data registers on the RDATA buses 220-223 when the DSP processor 10 intends to read data from a selected accelerator to the registers. In the preferred embodiment, the internal DSP registers are denoted GRx and GRy, as shown in FIG. 2. In this embodiment, the 4-bit address is stored in the register address field RAF and this field can be omitted if the accelerator instruction does not access the registers inside the DSP processor 10. Therefore, the width of the custom field CF can be augmented to convey more commands and parameters.

The register operation mode field ROMF comprises a plurality of bits to indicate the usage condition of the internal registers GRx and GRy in the DSP processor 10 and the usage condition of the internal register in the selected accelerator. For example, the logical value “0” may indicate “Don't use register operand for the accelerator” and the logical value “1” may indicate “Use register operand for the accelerator.” However the bit number and logical assignment can be changed according to design choice.

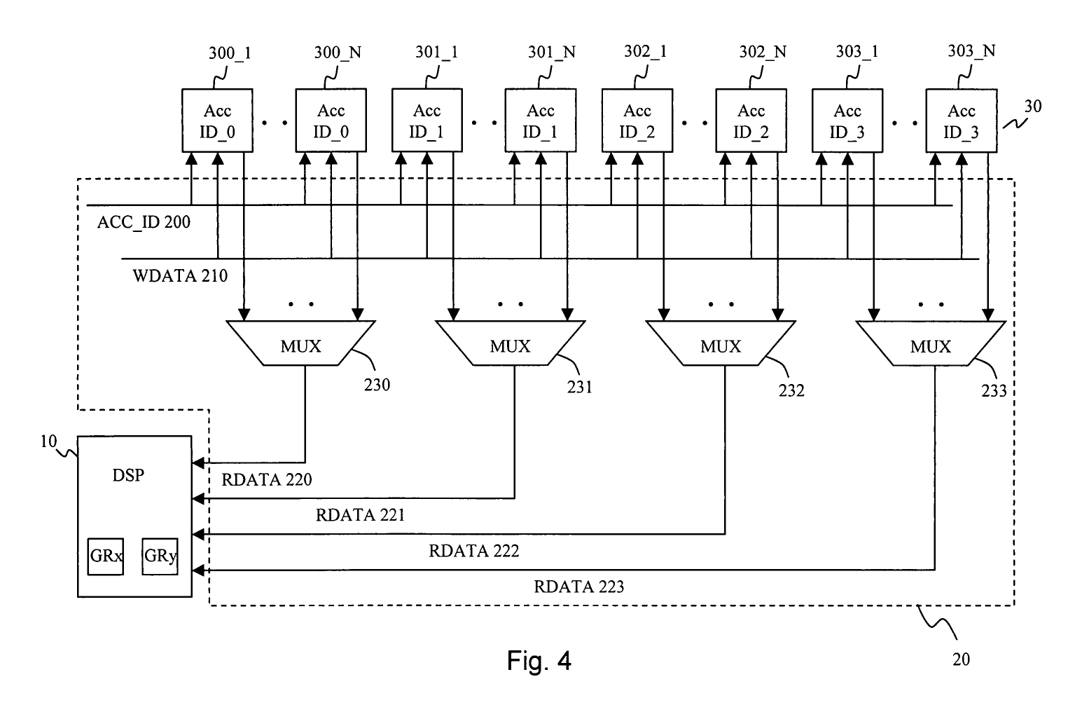

It is possible to connect more than four accelerators to the accelerator interface 20 by clustering several accelerators with the same accelerator ID. FIG. 4 shows the schematic diagram of a DSP system according to another preferred embodiment of the present invention. The DSP system in this preferred embodiment is similar to that shown in FIG. 2 except that a plurality of accelerators is clustered to share the same accelerator ID and the plurality of accelerators in the same cluster is connected to an RDATA bus through a multiplexer. Taking the first cluster with ACC ID_0 as an example, the plurality of accelerators 300_1 to 300_N are connected to corresponding RDATA bus 220 through a multiplexer 230. If the DSP processor 10 intends to access a specific accelerator 300_{—}x in the first cluster with ID ACC ID_0, the DSP processor 10 issues an accelerator instruction containing the accelerator ID field AIF for designating ACC ID_0. The specific accelerators 300_{—}x in the first cluster can be identified by discriminating the rest information other than the accelerator ID field in the instruction. For example, the command information stored in the CF filed of the accelerator instruction may only be executable or discernible by the specific accelerators 300_{—}x in the first cluster. The accelerators 300_{—}x is then eligible for this accelerator instruction.

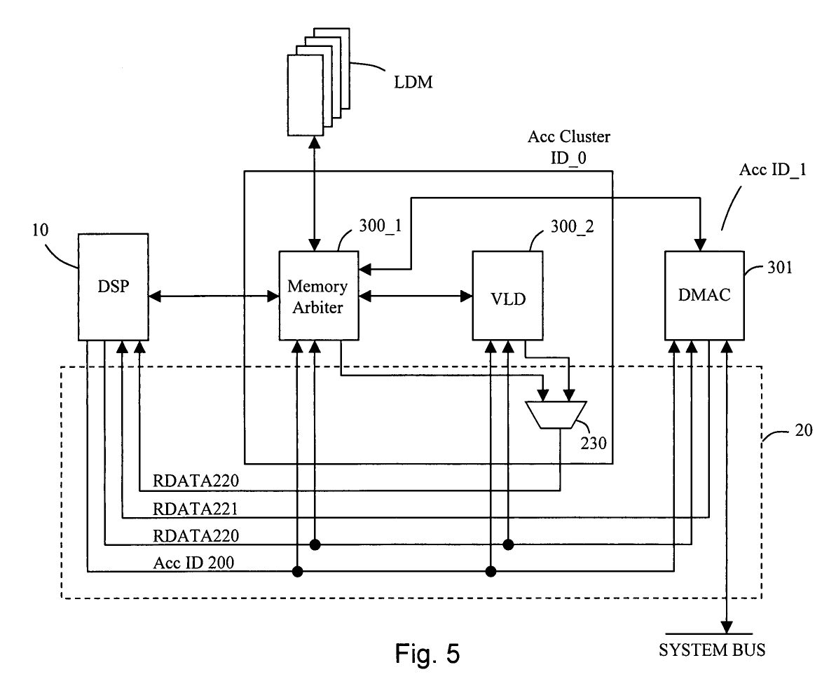

FIG. 5 shows the schematic diagram of a working example according to still another preferred embodiment of the present invention. In this DSP system, the first cluster with ID_0 contains two accelerators 300_1 and 300_2. The accelerator 300_1 is a memory arbiter (MARB) accelerator 300_1 and the accelerator 300_2 is a variable length decoder (VLD) accelerator 300_2. The MARB accelerator 300_1 and the VLD accelerator 300_2 are connected to an RDATA bus 220 through a multiplexer 230. There is only one accelerator associated with ACC ID_1 in this embodiment, namely, the DMA controller (DMAC) accelerator 301. The DMAC accelerator 301 is directly connected to a dedicated RDATA bus 221. When the DSP processor 10 intends to access the MARB accelerator 300_1, the DSP processor 10 issues an accelerator instruction with bit [23:20] set to be “1100”. The content “11” in bit [23:22] manifests the instruction as an accelerator instruction. The content “00” in bit [21:20] designates the accelerator instruction associated with the cluster with ACC ID_0. Whether this accelerator instruction is for the MARB accelerator 300_1 or the VLD accelerator 300_2 can be identified through the remaining bit [19:0]. More particularly, the MARB accelerator 300_1 can identify its instruction through the syntax eligibility in bit [19:0]. One should also note that an accelerator could request connecting to the DSP processor 10 via hardware interrupt request and therefore the accelerator can connect to other units in the DSP system such as local data memory (LDM) in FIG. 5 and other peripherals (not shown) connected to the DSP system through the system bus such as an AHB (Advanced High performance Bus).

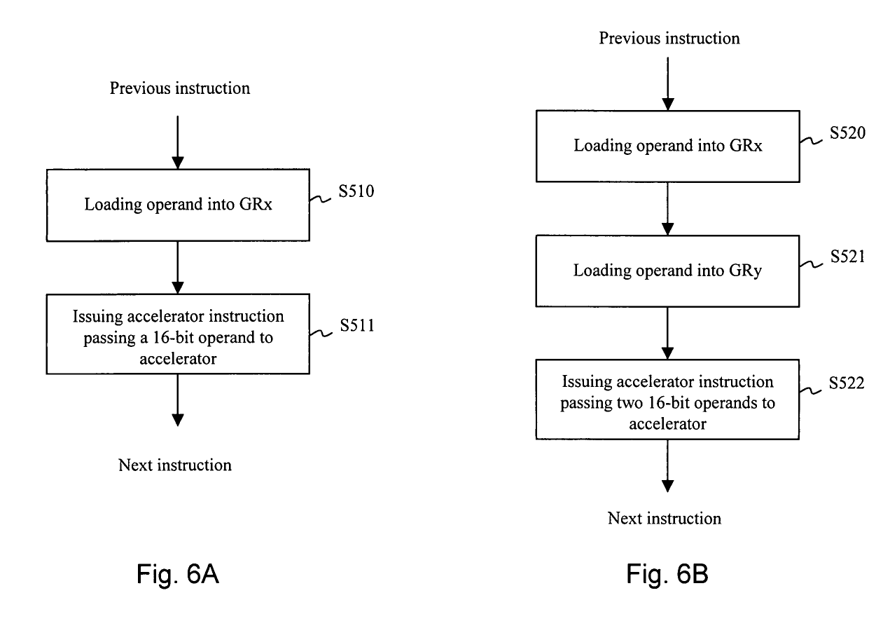

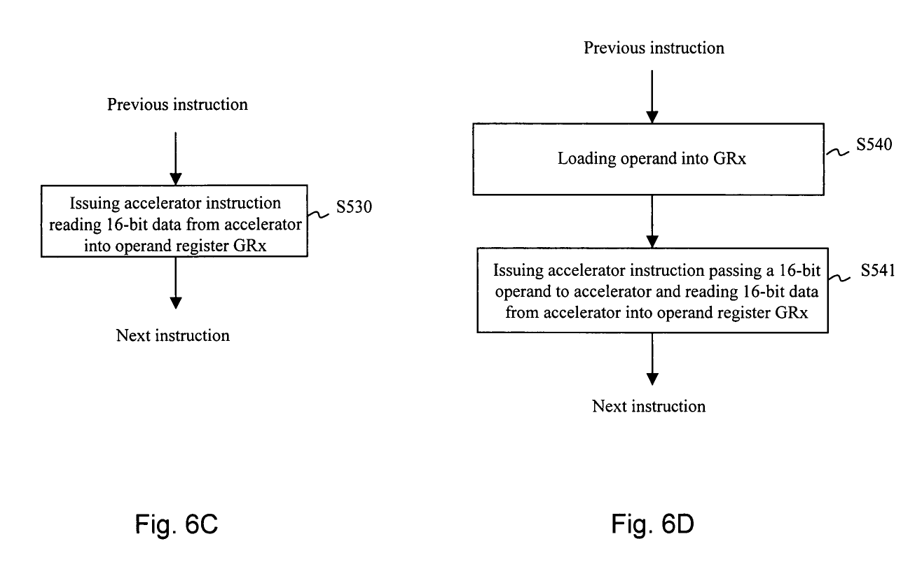

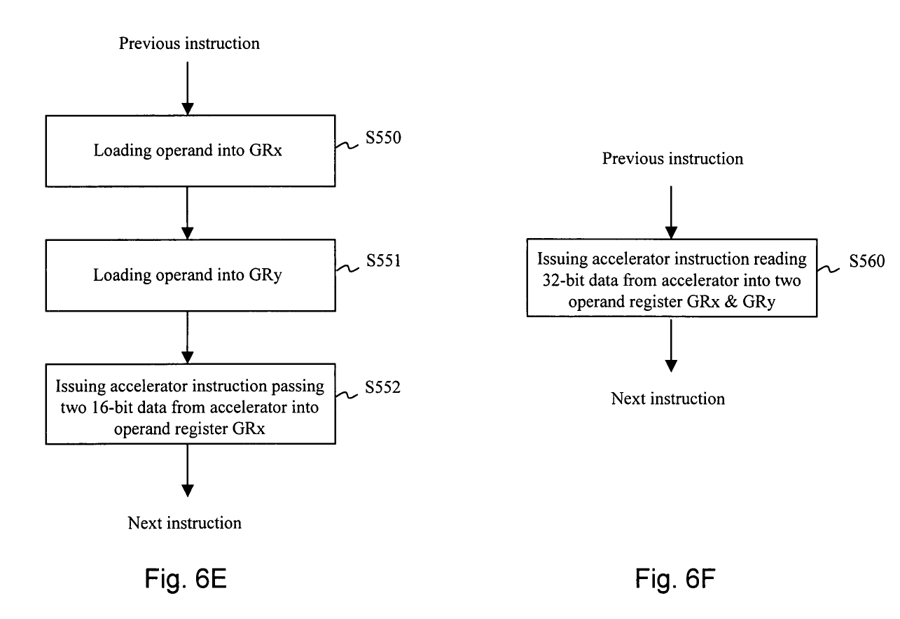

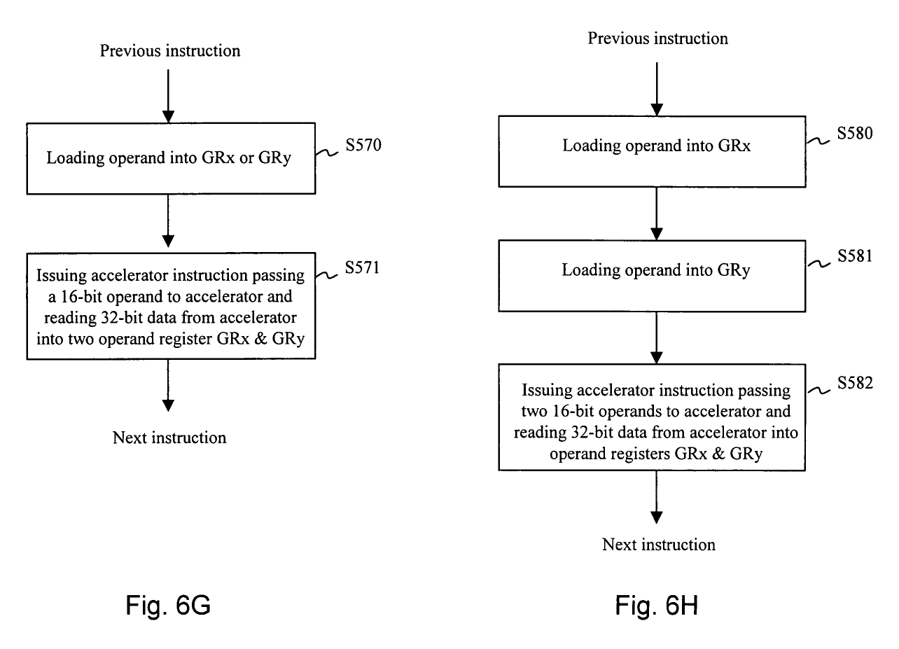

All instructions issued by the DSP processor 10 are visible on the ACC_ID bus 200. Whenever an accelerator instruction is present, the accelerator instruction will be decoded and executed by the selected accelerator 30x for which the accelerator instruction was designed. The accelerator instruction may instruct the accelerator 30x to use data off of the WDATA bus 210 (driven by the selected GRx and GRy internal registers), and/or to return data over the RDATA bus 22x into the DSP internal registers. The accelerator instructions according to the present invention are classified into four types for demonstration and described with reference to FIGS. 6A to 6H.

Type I Instruction

This accelerator instruction indicates no data return and no register operands, and has exemplary format as follows:
11AA-00CC-CCCC-CCCC-CCCC-CCCC

More particularly, the accelerator field AF is “11” to indicate it is an accelerator instruction. The accelerator ID field AIF is “AA” to indicate a specific accelerator ID. The register operation mode field ROMF is “00” to indicate the internal register not being used. The custom field CF contains an 18-bit command for the accelerator. For the DSP system shown in FIG. 4, a specific cluster can be selected by the accelerator ID field AIF and a specific accelerator in the cluster can be selected by reference to the content of the custom field CF.

Type II Instruction

This accelerator instruction indicates no data return and with DSP register operands, and has exemplary format as follows:
11AA-01CC-CCCC-CCCC-xxxx-yyyy

where “xxxx” indicates the address for the register GPx and “yyyy” indicates the address for the register GPy.

More particularly, the accelerator field AF is “11” to indicate it is an accelerator instruction. The ID field AIF is “AA” to indicate a specific accelerator ID. The register operation mode field ROMF is “01” to indicate the accelerator uses internal register operand from the DSP processor 10. The custom field CF contains 10-bit command for the accelerator and can be extended to 14 bit when one register operand (for example, the operand y in the register GRy) is not used.

FIG. 6A shows the flowchart explaining the operation of an instruction in the type II format, where only one DSP internal register GRx is accessed. The DSP processor 10 first loads an operand into the 16-bit register GRx in step S510 and then issues an accelerator instruction for passing the operand in the register GRx to a selected accelerator in step S511. The accelerator instruction for the operation shown in FIG. 6A has an exemplary format as follows:
11AA-01CC-CCCC-CCCC-xxxx-CCCC

FIG. 6B shows the flowchart explaining the operation of another instruction in the type II format, where the DSP internal registers GPx and GPy are accessed. The DSP processor 10 loads an operand into 16-bit register GRx in step S520 and then loads another operand into 16-bit register GRy in step S521. Thereafter, the DSP processor 10 issues an accelerator instruction for passing the operands in the registers GRx and GRy to a selected accelerator in step S522.

The accelerator instruction for the operation shown in FIG. 6B has an exemplary format as follows:
11AA-01CC-CCCC-CCCC-xxxx-yyyy
   Type III Instruction

This accelerator instruction indicates the selected accelerator returning 16 bits of data and optionally using DSP register operands, and has an exemplary format as follows:
11AA-1R0C-CCCC-CCCC-xxxx-yyyy

More particularly, the accelerator field AF is “11” to indicate it is an accelerator instruction. The accelerator ID field AIF is “AA” to indicate a specific accelerator ID. The register operation mode field ROMF is “1R0” to indicate the usage condition for an internal register. For parameter R, the logical value “0” indicates “Don't use register operand for the accelerator” and the logical value “1” indicates “Use register operand for the accelerator.” The custom field CF contains a 9-bit command for the selected accelerator and can be extended to 13 bits in case that one register operand (for example, the operand y in register GRy) is not needed.

FIG. 6C shows the flowchart explaining the operation of an instruction in the type III format, where only one DSP internal register GRx is accessed and the selected accelerator does not read any operand in the DSP internal register GRx. The DSP processor 10 issues an accelerator instruction for reading an operand in the selected accelerator to the internal register GRx in step S530.

The accelerator instruction for the operation shown in FIG. 6C has an exemplary format as follows:
11AA-100C-CCCC-CCCC-xxxx-CCCC

FIG. 6D shows the flowchart explaining the operation of another instruction in the type III format, wherein only one DSP internal register GRx is accessed and the selected accelerator also reads operands in the DSP internal register GRx. The DSP processor 10 first loads a 16-bit operand into the 16-bit register GRx in step S540, and then issues an accelerator instruction for passing the 16-bit operand to the selected accelerator and reading an operand in the selected accelerator to the internal register GRx in step S541.

The accelerator instruction for the operation shown in FIG. 6D has an exemplary format as follows:
11AA-110C-CCCC-CCCC-xxxx-CCCC

where the parameter R is set to logical 1 to indicate using the register operand for the selected accelerator.

FIG. 6E shows the flowchart explaining the operation of still another instruction in the type III format, where two DSP internal registers GRx and GRy are accessed and the selected accelerator also reads operands in the DSP internal register GRx. The DSP processor 10 first loads a 16-bit operand into a 16-bit register GRx in step S550. The DSP processor 10 loads a 16-bit operand into a 16-bit register GRy in step S551. Thereafter, the DSP processor 10 issues an accelerator instruction for passing the two 16-bit operands to the selected accelerator and for reading an operand in the selected accelerator to the internal register GRx in step S552.

The accelerator instruction for the operation shown in FIG. 6E has an exemplary format as follows:
11AA-110C-CCCC-CCCC-xxxx-yyyy
   Type IV Instruction

This accelerator instruction indicates the selected accelerator returning 32 bits of data and optionally using DSP register operands, and has an exemplary format as follows:
11AA-1R1-CCCC-CCCC-RORx-RORy

FIG. 6F shows the flowchart explaining the operation of an instruction in the type IV format, where two DSP internal register GRx and GRy are accessed. The DSP processor 10 issues an accelerator instruction for returning the 32-bit operand in the selected accelerator into two DSP internal registers GRx and GRy in step S560.

The accelerator instruction for the operation shown in FIG. 6F has an exemplary format as follows:
11AA-101C-CCCC-CCCC-xxxx-yyyy.

FIG. 6G shows the flowchart explaining the operation of another instruction in the type IV format, where two DSP internal register GRx and GRy are accessed, and the selected accelerator also reads operands in one of the DSP internal registers GRx and GRy. The DSP processor 10 loads a 16-bit operand to one of the DSP internal registers GRx and GRy in step S570. Thereafter, the DSP processor 10 issues an accelerator instruction for passing the 16-bit operand to the selected accelerator and returning a 32-bit data from the accelerator into the two DSP internal register GRx and GRy in step S571.

The accelerator instruction for the operation shown in FIG. 6G has an exemplary format as follows:
11AA-111C-CCCC-CCCC-xxxx-yyyy.

FIG. 6H shows the flowchart explaining the operation of still another instruction in the type IV format, where two DSP internal register GRx and GRy are accessed, and the selected accelerator also reads operands in both of the DSP internal registers GRx and GRy. The DSP processor 10 loads a 16-bit operand to the DSP internal registers GRx in step S580, then loads another 16-bit operand to the DSP internal registers GRy in step S581. Thereafter, the DSP processor 10 issues an accelerator instruction for passing the two 16-bit operands to the selected accelerator and returning a 32-bit data from the selected accelerator into the two DSP internal register GRx and GRy in step S582.

The accelerator instruction for the operation shown in FIG. 6H has an exemplary format as follows:
11AA-111C-CCCC-CCCC-xxxx-yyyy.

The instruction formats are not limited to those listed above. The instructions can be modified to access more internal registers in the DSP processor and to support more complicated operations as long as the selected accelerator can be manifested in the instructions.

In the present invention, the DSP processor 10 and the accelerators are configured to support a pipeline extension mode and slave mode operation. The pipeline extension mode instructions are executed by the accelerator in-line with the DSP processor pipeline. As an example, a pipeline extension mode instruction returning data from the accelerator will update the destination register (GRx and/or GRy) inside the DSP processor in a clock cycle. At the same clock cycle, any other DSP instruction would update the same register. Pipeline extension mode instructions execute in one clock cycle and they provide the possibility of sending data to the accelerator and receiving modified data back to the DSP processor in one clock cycle. This is a very powerful feature that conventional processor buses do not support.

Slave mode instructions are executed by the accelerator over a number (often nondeterministic) of clock cycles. Polling or interrupt signaling is then used to indicate when the instruction has been completed. Both the pipeline and slave mode accelerator instruction provide an extension to the DSP instruction set and can be used to optimize overall performance. When a slave mode accelerator instruction is issued by the DSP processor, the time for the accelerator to execute the instruction is usually not known by the DSP processor. The present invention further provides a method for operating the DSP system for a slave mode operation.

FIG. 7 is a flowchart showing that the accelerators operate in a slave mode and the DSP processor uses polling to check the finishing of the accelerator operation. The DSP processor issues a slave mode accelerator instruction in step S700, where the accelerator instruction has a format similar to that shown in FIG. 3. All the accelerators connected to the DSP processor receive the accelerator instruction and a selected accelerator is identified through the accelerator instruction in step S702. The DSP processor continues with other tasks in step S704, and the selected accelerator continues with its processing at the same time. Herein, the selected accelerator will issue a ready flag to indicate that it has completed its processing in step S706. The DSP processor uses polling to check whether the accelerator has completed the instruction by examining the ready flag in step S710. If the ready flag is not set, the procedure is back to step S704; alternatively, the following steps are executed. The DSP processor reads the result in the selected accelerator in step S712 and then the ready flag is cleared in the selected accelerator in step S714. The accelerator can also use interrupt to inform the DSP processor that the instruction has been completed. When using the interrupt control mechanism, the DSP processor needs not poll the ready flag (read the flag and test it) in the accelerator, while the reading of the result and clearing of the ready flag are done by the DSP processor in an interrupt service routine.

Although several embodiments are specifically illustrated and described herein, it will be appreciated that modifications and variations of the present invention are covered by the above teachings and within the purview of the appended claims without departing from the spirit and intended scope of the present invention.

What is claimed is:

1. A digital system comprising:
a processor;
at least one accelerator; and
an accelerator interface comprising an accelerator identification (ID) bus and bridged between the processor and the at least one accelerator, wherein the accelerator interface receives an instruction from the processor and sent the received instruction to one specific accelerator of the at least one accelerator, wherein the instruction contains an accelerator field (AF) to manifest the instruction being an accelerator-related instruction.

2. The digital system as in claim 1, wherein the accelerator interface further comprises a write data bus for writing data to the at least one accelerator and at least one read data bus for reading data from the at least one accelerator.

3. The digital system as in claim 2, wherein each on the read date bus is bridged between the processor and at least one accelerator.

4. The digital system as in claim 1, wherein the instruction further comprises at least one of the followings:
an accelerator identification field (AIF) to identify the specific accelerator;
a custom field (CF) to indicate an command code for the specific accelerator;
a register operation mode field (ROMF) to indicate a usage condition of at least one internal register.
an internal register address field (RAF) to indicate the address of at least one register in the processor.

5. The digital system as in claim 4, wherein the custom field further conveys other information.

6. The digital system as in claim 4, wherein each of the internal registers used by the register operation mode filed is located in the specific accelerator or the processor.

7. The digital system as in claim 1, wherein the at least one accelerator are grouped into at least one cluster.

8. The digital system as in claim 7, wherein the accelerators grouped in a same cluster are connected to one read data bus through a multiplexer.

9. The digital system as in claim 1, wherein the processor and the accelerator are configured to support a pipeline mode operation or a slave mode operation.

10. The digital system as in claim 9, wherein the accelerator responses to the processor through an interruption in the slave mode operation.

11. The digital system as in claim 9, wherein the processor inquires the accelerator through a polling operation.

12. The digital system as in claim 9, wherein any instruction of the pipeline mode operation is executed by the at least one accelerator in-time with the processor pipeline, and any instruction of the slave mode instruction is executed by the at least one accelerator over a number of clock cycles.

13. In a digital system, a processor is connected to at least one accelerator through an interface, a method for operating the digital system comprising the steps of:
sending an instruction containing an accelerator field (AF) from the processor to the at least one accelerator through the interface; and
identifying whether the instruction is an accelerator instruction in the at least one accelerator by identifying the accelerator field.

14. The method as in 13, further comprising the steps of:
providing an accelerator identification field (AIF) in the instruction; and
specifying a designated accelerator according to the accelerator identification field.

15. The method as in 13, further comprising the step of:
adding a register operation mode field (ROMF) in the instruction to indicate a usage condition of an internal register of the processor.

16. The method as in 13, further comprising the step of:
providing a custom field (CF) in the instruction to indicate a command code for the accelerator.

17. The method as in 16, further comprising the steps of:
grouping the at least one accelerator into at least one cluster; and
identifying each accelerator in which of the at least one cluster by the custom field.

18. The method as in 14, further comprising the steps of:
the processor issuing a slave mode accelerator instruction designating one accelerator, wherein any instruction of the slave mode instruction is executed by the at least one accelerator over a number of clock cycles; and
the designated accelerator issuing a ready flag when the designated accelerator finishes the instruction.

19. The method as in 14, further comprising the steps of:
the processor issuing a slave mode accelerator instruction designating one accelerator, wherein any instruction of the slave mode instruction is executed by the at least one accelerator over a number of clock cycles; and
the designated accelerator issuing an interrupt request when the designated accelerator finishes the instruction.

20. The method as in 14, wherein the processor and the at least one accelerator are configured to operate in a pipeline mode, wherein any instruction of the pipeline mode operation is executed by the at least one accelerator in-time with the processor pipeline.

21. An instruction issued by a processor to control at least one accelerator connected to the processor through an interface, the instruction comprising:
an accelerator field (AF) to indicate that the instruction is an accelerator-related instruction.

22. The instruction as in claim 21, wherein the instruction further comprises at least one of the following:
an accelerator identification field (AIF) to select a designated accelerator;
a custom field (CF) to indicate an instruction code for the designated accelerator;
a register operation mode field (ROMF) to indicate a usage condition of an internal register of the processor; and
a register address field (RAF) to indicate at least one internal register in the processor.
